(19) United States
(12) Patent Application Publication
(10) Pub. No.: US 2017/0212945 A1
(43) Pub. Date: Jul. 27, 2017

(54) BRANCHABLE GRAPH DATABASES

(71) Applicant: LinkedIn Corporation, Mountain View, CA (US)

(72) Inventors: Shyam Shankar, Sunnyvale, CA (US); Scott M. Meyer, Berkeley, CA (US)

(73) Assignee: LinkedIn Corporation, Mountain View, CA (US)

(21) Appl. No.: 15/003,527

(22) Filed: Jan. 21, 2016

(51) Int. Cl. G06F 17/30

(52) U.S. Cl. CPC G06F 17/30581; G06F 17/30368; G06F 17/30371; G06F 17/30377; G06F 17/30477; G06F 17/30958

(57) ABSTRACT

The disclosed embodiments provide a system for providing a graph database storing a graph. During operation, the system executes one or more processes for providing the graph database. Next, the system stores a sequence of changes to the graph in a base version of the graph database. The system then branches a version of the graph database from a virtual time in the base version. Finally, the system uses the branched version to process one or more queries of the graph database.

### RELATED APPLICATION

The subject matter of this application is related to the subject matter in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US).

### BACKGROUND

Field

The disclosed embodiments relate to graph databases. More specifically, the disclosed embodiments relate to techniques for providing branchable graph databases.

Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

A variety of approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers, i.e., in a manner consistent with the application's perspective. However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows an exemplary branching of a graph database in accordance with the disclosed embodiments.

FIG. 4 shows a flowchart illustrating the process of providing a graph database storing a graph in accordance with the disclosed embodiments.

FIG. 5 shows a flowchart illustrating the process of using a branched version of a graph database to process queries of the graph database in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

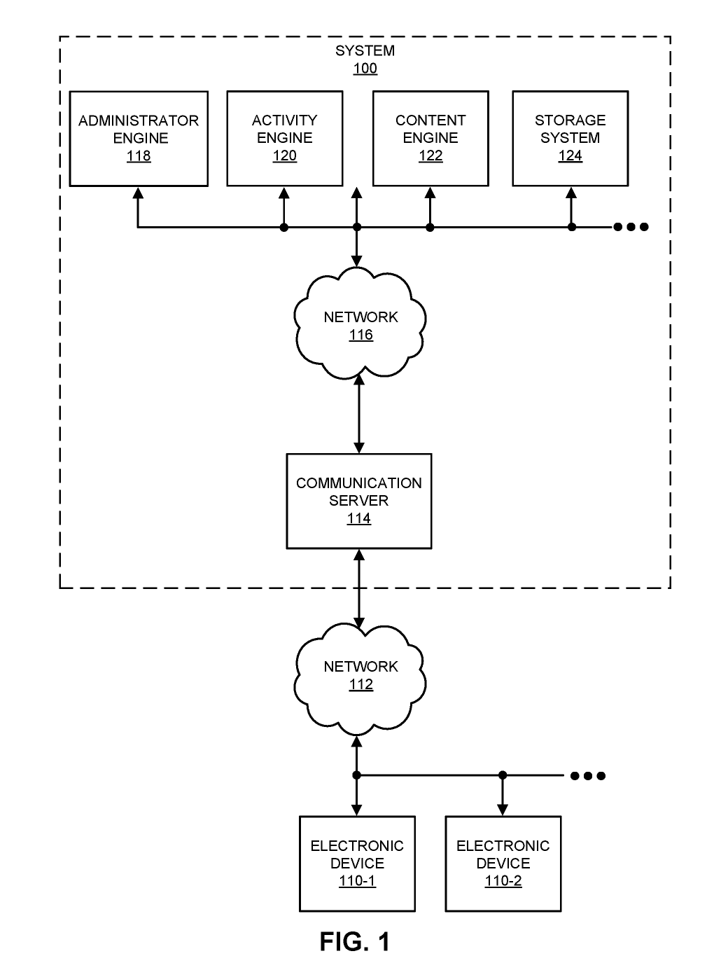

The disclosed embodiments provide a method, apparatus and system for processing queries of a graph database. A system 100 for performing a graph-storage technique is shown in FIG. 1. In this system, users of electronic devices 110 may use a service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices, i.e., a large-scale storage system.

Note that each of the users of the social network may have an associated user profile that includes personal and professional characteristics and experiences, which are sometimes collectively referred to as ‘attributes’ or ‘characteristics.’ For example, a user profile may include: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors may include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the social network.

In order to address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

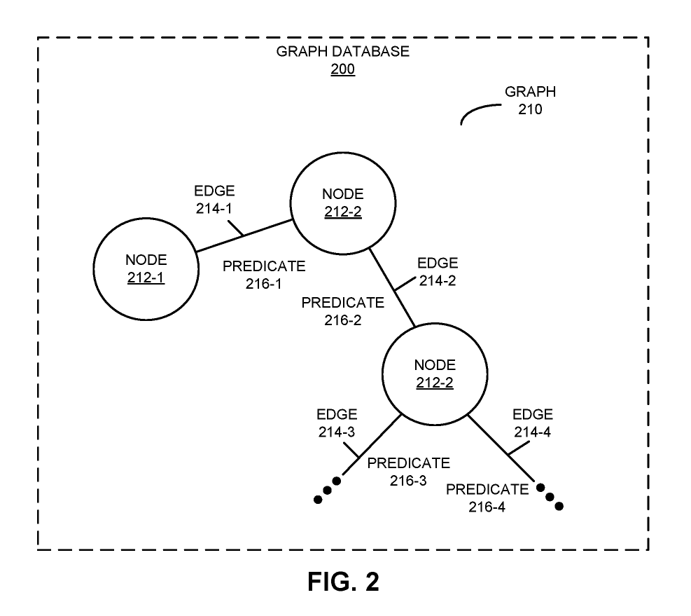

FIG. 2 presents a block diagram illustrating a graph 210 stored in a graph database 200 in system 100 (FIG. 1). Graph 210 may include nodes 212, edges 214 between nodes 212, and predicates 216 (which are primary keys that specify or label edges 214) to represent and store the data with index-free adjacency, i.e., so that each node 212 in graph 210 includes a direct edge to its adjacent nodes without using an index lookup.

Note that graph database 200 may be an implementation of a relational model with constant-time navigation, i.e., independent of the size N, as opposed to varying as log(N). Moreover, all the relationships in graph database 200 may be first class (i.e., equal). In contrast, in a relational database, rows in a table may be first class, but a relationship that involves joining tables may be second class. Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that preserves intact the structure (i.e., nodes, edges) of the subset of graph 210.

The graph-storage technique may include embodiments of methods that allow the data associated with the applications and/or the social network to be efficiently stored and retrieved from graph database 200. Such methods are described in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US), which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

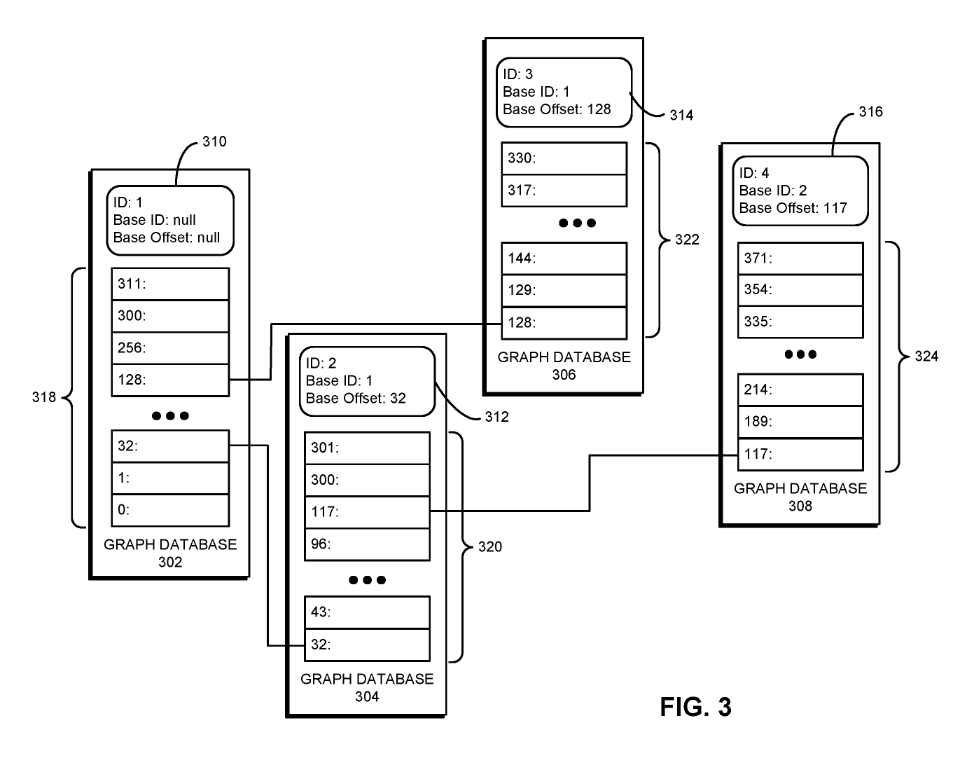

In one or more embodiments, system 100 includes functionality to process queries of graph database 200 using one or more branches of graph database 200. As shown in FIG. 3, a graph database 302 may include a log 318 containing a sequence of changes to the graph, with each change represented by an offset in log 318. For example, a number of updates to nodes, edges, and/or predicates of the graph may be stored at numeric offsets 0, 1, 32, 128, 256, 300, and 311 of graph database 302.

Graph database 302 may be accessed by a number of processes that process queries of graph database 302. For example, the processes may include a write process that executes write requests to the graph database and one or more read processes that execute read requests to the graph database.

Each change in log 318 may be used to add a node, edge, and/or predicate to the graph; modify an existing node or edge; and/or remove a node, edge or predicate from the graph. Thus, the graph may be constructed by applying the changes in log 318 in order, from offset 0 to offset 311. For example, log 318 may include a sequence of the following three changes: a new node named “A,” a new node named “B,” and a predicate named “connected to.” An edge representing a connection between “A” and “B” may then be added to log 318 using a (subject, predicate, object) triple. Within the triple, the subject may reference the offset of the first change, the predicate may reference the offset of the third change, and the object may reference the offset of the second change.

Offsets of graph changes in log 318 may also be referenced by indexes and/or other mechanisms for resolving queries of graph database 302. For example, an index of edges in the graph may store offsets of changes to the edges in log 318. A query for edges that match one or more attributes may be resolved by looking up a record in the index that contains the attributes, obtaining a set of log 318 offsets from the record, and using the offsets to resolve additional attributes of the edges.

Because log 318 preserves the ordering of changes to the graph, offsets in log 318 may be used as representations of virtual time in the graph. More specifically, each offset may represent a different virtual time in the graph, and changes in log 318 up to the offset may be used to establish a state of the graph at the virtual time. For example, the sequence of changes from the beginning of log 318 (e.g., offset 0) up to a given offset that is greater than 0 may be applied, in the order in which the changes were written, to construct a representation of the graph at the virtual time represented by the offset.

The storing of sequential changes to the graph at various offsets in log 318 may additionally allow multiple versions of the graph to be stored in additional graph databases 304-308 that branch off a previously created graph database. For example, graph databases 304-306 may branch off graph database 302, and graph database 308 may branch off graph database 304. Graph database 302 may thus represent a “base version” off which graph databases 304-306 branch, and graph database 304 may represent a “base version” off which graph database 308 branches. Moreover, graph database 302 may be a main or “master” version that is used as a source of truth for the graph, while graph databases 304-308 may store variants or alternative versions of the graph.

Like graph database 302, graph databases 304-306 individually contain logs 320-324 of ordered changes to the graph, with each change represented by an offset in the corresponding log. A separate index may also be created from each log to expedite querying of the corresponding graph database.

In one or more embodiments, the virtual time maintained by offsets in logs 318-324 is used to manage different versions of the graph stored in graph databases 304-308. As shown in FIG. 3, graph databases 302-308 contain headers 310-316 that store metadata related to the creation and/or versioning of the graph databases. Each header may specify an identifier (e.g., “ID”) for the corresponding graph database, a base identifier for a base version (e.g., “Base ID”) from which the graph database is created, and an offset of the base version (e.g., “Base Offset”) off which the graph database is branched.

Header 310 of graph database 302 includes an identifier of “1” and null values for the base identifier and base offset, indicating that graph database 302 is not created from another graph database. Header 312 of graph database 304 includes an identifier of “2,” a base identifier of “1,” and a base offset of “32,” indicating that graph database 304 is created from graph database 302 at a virtual time represented by an offset of 32 in log 318. Header 314 of graph database 306 includes an identifier of “3,” a base identifier of “1,” and a base offset of “128,” indicating that graph database 306 is created from graph database 302 at a virtual time represented by an offset of 128 in log 318. Header 316 of graph database 308 includes an identifier of “4,” a base identifier of “2,” and a base offset of “117,” indicating that graph database 308 is created from graph database 304 at a virtual time represented by an offset of 117 in log 320.

Graph databases 304-308 may include changes to the corresponding base versions, up to the base offsets from which the graph databases are branched. Conversely, changes tracked in logs 320-324 of graph databases 304-308 may not be visible to the corresponding base versions. For example, graph database 302 may include changes to the graph from offsets 0 to 311 in log 318. Graph database 304 may include changes to the graph from offsets 0 to 32 in log 318 and additional changes to the graph from offsets 32 to 301 in log 320. Graph database 306 may include changes to the graph from offsets 0 to 128 in log 318 and additional changes to the graph from offsets 128 to 330 in log 322. Graph database 308 may include changes to the graph from offsets 0 to 32 in log 318, changes to the graph from offsets 32 to 117 in log 320, and changes to the graph from offsets 117 to 371 in log 324. In other words, offsets of changes in a branched graph database may represent virtual times that occur after the offset in the corresponding base version from which the graph database is branched.

To manage and/or resolve differences across different graph database versions, changes tracked by a given graph database may be merged into the base version off which the graph database branches. For example, graph changes in graph database 308 may be merged into graph database 304, and graph changes in graph databases 304-306 may be merged into graph database 302. If the base version has not been modified since the virtual time (e.g., offset) from which the graph database is branched, the graph database may be merged into the base version by appending changes from the branched graph database to the offset in the base version.

Conversely, if changes to the graph have been added to the base version after the offset from which the graph database is branched, the changes to the base version may be combined with additional changes from the branched graph database, and the combined changes may be written to the base version after the offset. Any conflicts between the two sets of changes may be resolved by prioritizing one set of changes over another, obtaining user input for resolving the conflicts, and/or applying another mechanism for resolving merge conflicts. For example, graph database 304 may be merged into graph database 302 using a “rebasing” operation that applies the changes in log 320 on top of changes in log 318, thereby prioritizing changes in graph database 304 over conflicting changes in graph database 302.

Those skilled in the art will appreciate that graph databases (e.g., graph databases 302-308) containing multiple versions of a graph may be combined and/or split in other ways. For example, a sequence of changes from a first virtual time (e.g., offset) to a second virtual time in a first graph database may be extracted and stored in a second graph database. The extracted sequence of changes may also be merged into a third graph database, independently of any relationship between the third graph database and the first graph database. In another example, changes in a branched graph database may be merged with changes to the corresponding base version after the offset off which the graph database is branched, and the merged changes may be written to the branched graph database instead of the base version.

The storing of different versions of the graph in multiple graph databases (e.g., graph databases 302-308) may be used to process queries of the graph databases in a number of ways. First, different sets of changes in the graph databases may be used to return different results to the same query. For example, the storing of different sets of edge changes in logs 318-324 may cause different sets of edges to be returned by graph databases 302-308 in response to a query for edges matching one or more attributes. One or more branched graph databases (e.g., graph databases 304-308) may thus be used to store temporary and/or “fictitious” changes to the corresponding base versions, and queries of a branched graph database may be performed to analyze the effect of such changes on the graph stored in the base version. For example, edges representing the hypothetical connection of a member to other members of a social network may be added to a branched graph database, and a query may be processed using the branched graph database to assess the potential effect of the edges on the member's second-degree network (e.g., all members that are up to two degrees of separation from the member). In another example, one or more branched graph databases may store intermediate results or changes associated with a recursive analysis of nodes, edges, and/or predicates in the graph. After the recursive analysis is complete, changes in the branched graph database(s) may be merged into the corresponding base version.

Along the same lines, a branched graph database may temporarily store conditional changes to the graph. After one or more conditions associated with the changes are met, the changes may be merged back into the corresponding base version. For example, the branched graph database may contain one or more edge changes representing a member's self-declared employment at a company and/or enrollment at an educational institution. After the legitimacy of the relationships represented by the edges is independently verified, the branched graph database may be merged into the corresponding base version to “commit” the changes to the base version.

One or more branched graph databases 304-308 may also be used to store and/or validate writes to graph database 302 before the writes are applied to graph database 302. For example, a write request to graph database 302 that is received at a virtual time represented by offset 128 of log 318 may be processed by branching graph database 306 off graph database 302. After graph database 306 is created, a number of changes from the write request may be written to log 322. Log 322 may then be analyzed to verify that the changes were successfully written before the changes are merged into graph database 302. In another example, a branched graph database may be used to process read and write requests to the graph during a user session. After the user session is terminated, changes written to the branched database may be merged into the corresponding base version.

Finally, an empty branched graph database may be created from a given offset of another graph database to generate a snapshot of the other graph database at the virtual time represented by the offset. The branched graph database may then be used to process only read requests while writes to the other graph database are made, thus ensuring the consistency of results returned in response to the read requests.

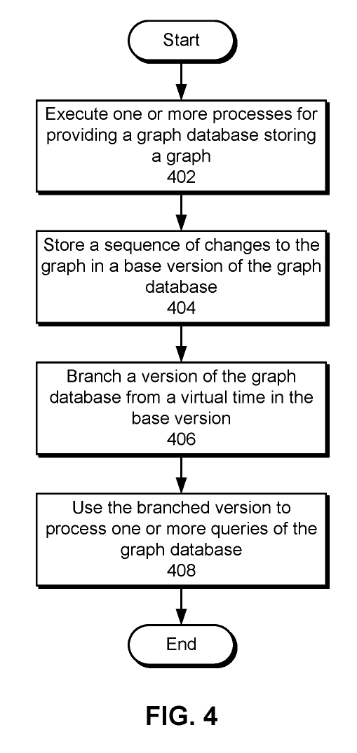

FIG. 4 shows a flowchart illustrating the process of providing a graph database storing a graph in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the technique.

Initially, one or more processes for providing a graph database storing a graph are executed (operation 402). For example, the processes may include a write process and one or more read processes that process queries of the graph database in a lock-free manner. The processes may also create an index from the graph database and use the index to process some or all of the queries.

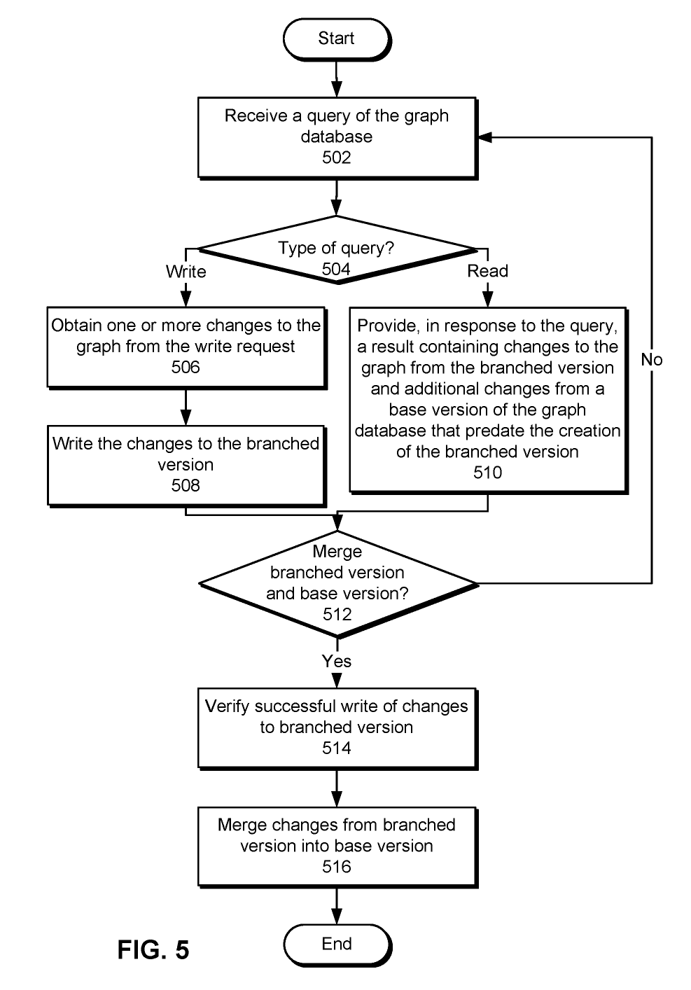

To maintain the graph database, the processes store a sequence of changes to the graph in a base version of the graph database (operation 404). For example, the processes may write the changes to a log in the graph database, with offsets in the log representing virtual times in the graph. Next, the processes branch a version of the graph database from a virtual time in the base version (operation 406). For example, the branched version may reference an offset of the base version representing the virtual time at which the branched version was created. In turn, offsets in the branched version may start at the referenced offset and increase as changes are added to the branched version. As a result, the branched version may contain a sequence of changes from the beginning of the log in the base version up to the referenced offset, as well as an additional sequence of changes tracked in a separate log of the branched version. Because changes in the branched version have offsets that are greater than the referenced offset, the changes in the branched version may be applied on top of changes from the beginning of the base version up to the referenced offset. Finally, the branched version is used to process one or more queries of the graph database (operation 408), as described in further detail below with respect to FIG. 5.

FIG. 5 shows a flowchart illustrating the process of using a branched version of a graph database to process queries of the graph database in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the technique.

First, a query of the graph database is received (operation 502). For example, the query may be a write request or read request that is directed to the branched version instead of a base version from which the branched version is created.

The query may be processed based on the type of the query (operation 504). If the query is a write request, one or more changes to a graph are obtained from the write request (operation 506) and written to the branched version (operation 508), which stores a representation of the graph. Because the changes are written to the branched version instead of the base version, the changes may be omitted from the processing of read requests to the base version. As a result, the branched version may be used to store temporary graph changes, “fictitious” graph changes, and/or intermediate changes or results associated with recursive analysis of the graph without affecting the state of the base version.

If the query is a read request, a result containing changes to the graph from the branched version and additional changes from the base version that predate the creation of the branched version is provided in response to the query (operation 510). For example, the read request may be processed by scanning the branched version and portions of the base version that predate the offset from which the branched version is created for graph changes that match one or more parameters of the read request. The matching graph changes may then be returned in response to the read request. In another example, a consistent view and/or snapshot of the graph database may be provided by maintaining an empty branched version that references an offset in the base version representing the virtual time at which the snapshot is made and using the branched version to process the read request independently of updates to the base version.

The branched version and base version may also be merged (operation 512) after use of the branched version to process queries is complete. Alternatively, merging of the branched version into the base version may be avoided if the state of the base version is to be unaffected by changes to the graph in the branched version.

If the branched version is to be kept separate from the base version, processing of queries using the branched version (operations 502-510) may continue until the changes stored in the branched version are no longer relevant to use cases associated with querying of the graph database. If the branched version is to be merged with the base version, a successful write of one or more changes to the branched version is verified (operation 514), and the changes from the branched version are merged into the base version (operation 516). For example, writes to the branched version performed in one or more iterations of operations 506-508 may be validated before the branched version is merged into the base version to prevent bad and/or incomplete writes from affecting the state of the base version. After the changes in the branched version are merged into the base version, the branched version may be discarded, or the branched version may continue to be used to process queries separately from the base version.

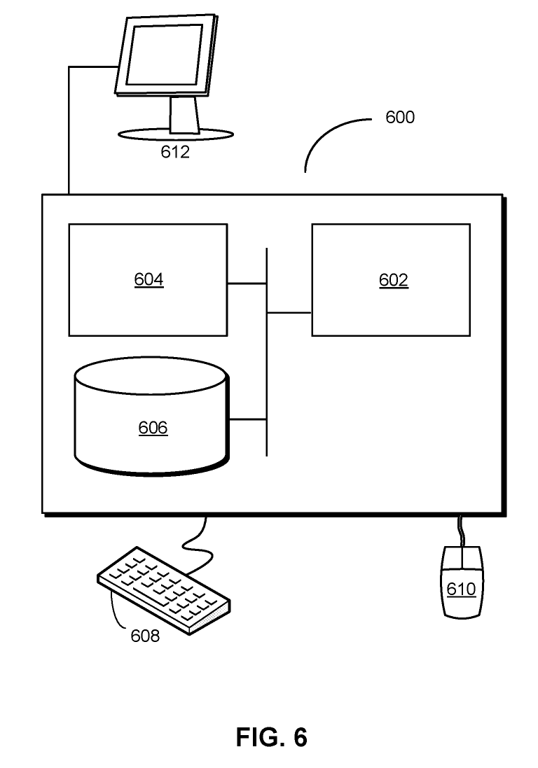

FIG. 6 shows a computer system 600 in accordance with an embodiment. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for providing a graph database storing a graph. The system may include one or more processes for providing the graph database. During maintenance of the graph database, the processes may store a sequence of changes to the graph in a base version of the graph database. Next, the processes may branch a version of the graph database from a virtual time in the base version. The processes may then use the branched version to process one or more queries of the graph database.

In addition, one or more components of computer system 600 may be remotely located and connected to the other components over a network. Portions of the present embodiments (e.g., base version, branched versions, processes, etc.) may also be located on different nodes of a distributed system that implements the embodiments. For example, the present embodiments may be implemented using a cloud computing system that uses one or more distributed versions of a graph database to process queries of the graph database from a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing, on a computer system, one or more processes for providing a graph database storing a graph, wherein the graph comprises a set of nodes, a set of edges between pairs of nodes in the set of nodes, and a set of predicates; and
maintaining, by the one or more processes, the graph database by:
storing a sequence of changes to the graph in a base version of the graph database;
branching a version of the graph database from a virtual time in the base version; and
using the branched version to process one or more queries of the graph database.

2. The method of claim 1, wherein using the branched version to process the one or more queries of the graph database comprises:
receiving a first query as a write request that comprises one or more additional changes to the graph; and
writing the one or more additional changes to the branched version.

3. The method of claim 2, wherein using the branched version to process the one or more queries of the graph database further comprises:
verifying a successful write of the one or more additional changes to the branched version; and
merging the one or more additional changes from the branched version into the base version.

4. The method of claim 3, wherein merging the one or more changes into the base version comprises:
appending the one or more additional changes to the sequence of changes in the base version.

5. The method of claim 3,
wherein the one or more additional changes are written to the branched version during a user session; and
wherein the one or more additional changes are merged from the branched version into the base version at an end of the user session.

6. The method of claim 2, wherein using the branched version to process the one or more queries of the graph database further comprises:
receiving a second query as a read request; and
providing, in response to the second query, a result that comprises the one or more additional changes from the branched version and one or more changes from the base version that predate a creation of the branched version.

7. The method of claim 2, wherein the one or more additional changes comprise one or more temporary changes to the graph database.

8. The method of claim 1, wherein branching the version of the graph database from the virtual time in the base version comprises:
referencing, from the branched version, an offset in the base version that represents the virtual time; and
using the branched version to track an additional sequence of changes to the graph after the virtual time.

9. The method of claim 1, wherein using the branched version to process the one or more queries of the graph database comprises:
using the branched version to process read requests independently of updates to the sequence of changes in the base version.

10. The method of claim 1, wherein using the branched version to process one or more queries of the graph database comprises:
creating an index from the branched version; and
using the index to process the one or more queries.

11. An apparatus, comprising:
one or more processors; and
memory storing instructions that, when executed by the one or more processors, cause the apparatus to:
execute one or more processes for providing a graph database storing a graph, wherein the graph comprises a set of nodes, a set of edges between pairs of nodes in the set of nodes, and a set of predicates;
store a sequence of changes to the graph in a base version of the graph database;
branch a version of the graph database from a virtual time in the base version; and
use the branched version to process one or more queries of the graph database.

12. The apparatus of claim 11, wherein using the branched version to process the one or more queries of the graph database comprises:
receiving a first query as a write request that comprises one or more additional changes to the graph; and
writing the one or more additional changes to the branched version.

13. The apparatus of claim 12, wherein using the branched version to process the one or more queries of the graph database further comprises:
verifying a successful write of the one or more additional changes to the branched version; and
merging the one or more additional changes from the branched version into the base version.

14. The apparatus of claim 13,
wherein the one or more additional changes are written to the branched version during a user session, and
wherein the one or more additional changes are merged from the branched version into the base version at an end of the user session.

15. The apparatus of claim 12, wherein using the branched version to process the one or more queries of the graph database further comprises:
receiving a second query as a read request; and
providing, in response to the second query, a result that comprises the one or more additional changes from the branched version and one or more changes from the base version that predate a creation of the branched version.

16. The apparatus of claim 12, wherein the one or more additional changes comprise one or more temporary changes to the graph database.

17. The apparatus of claim 11, wherein branching the version of the graph database from the virtual time in the base version comprises:
referencing, from the branched version, an offset in the base version that represents the virtual time; and
using the branched version to track an additional sequence of changes to the graph after the virtual time.

18. The apparatus of claim 11, wherein using the branched version to process the one or more queries of the graph database comprises:
using the branched version to process read requests independently of updates to the sequence of changes in the base version.

19. A system, comprising:
a management module comprising a non-transitory computer-readable medium comprising instructions that, when executed by one or more processors, cause the system to execute one or more processes for providing a graph database storing a graph, wherein the graph comprises a set of nodes, a set of edges between pairs of nodes in the set of nodes, and a set of predicates; and
a processing module comprising a non-transitory computer-readable medium comprising instructions that, when executed by the one or more processors, cause the system to maintain, by the one or more processes, the graph database by:
store a sequence of changes to the graph in a base version of the graph database;
branch a version of the graph database from a virtual time in the base version; and
use the branched version to process one or more queries of the graph database.

20. The system of claim 19, wherein branching the version of the graph database from the virtual time in the base version comprises:
referencing, from the branched version, an offset in the base version that represents the virtual time; and
using the branched version to track an additional sequence of changes to the graph after the virtual time.
